(19) United States
(12) Patent Application Publication
(10) Pub. No.: US 2008/0177574 A1
(43) Pub. Date: Jul. 24, 2008

(54) Systems and Methods To Improve The Efficiencies Of Immunization Registries

(76) Inventors: Marcos Lara Gonzalez, New York, NY (US); Alberto Lopez Toledo, Barcelona (ES); Miguel Lara Gonzalez, New York, NY (US); Raul Rodriguez-Esteban, New York, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/018,013

(22) Filed: Jan. 22, 2008

Related U.S. Application Data
(60) Provisional application No. 60/886,082, filed on Jan. 22, 2007.

(51) Int. Cl. G06Q 50/00

(52) U.S. Cl. 705/2

(57) ABSTRACT

Systems and methods are provided for setting up and sending healthcare alerts (e.g. immunization reminders) to patients/caregivers through the use of communications devices. In an embodiment, information about a patient's/caregiver's wireless device (e.g. cell phones) is collected and reported to an immunization registry. The registry is linked to a system that uses the wireless device information to generate automatic wireless immunization reminders, recalls and educational messages that are sent to the patient/caregiver. In a preferred embodiment, opt-in information is reported to the system to ensure that the patient/caregiver has consented to the automatic wireless immunization reminders. The system may also check the eligibility of patients to receive reminders, provide incentives for patients to receive reminders, provide follow up information (e.g. performed, not performed, responses to message/s) to a healthcare provide for a particular patient or a group of patients, and/or provide billing services for payment of the reminders.

### RELATED APPLICATIONS

This patent application claims the benefit of provisional U.S. Patent Application Ser. No. 60/886,082, entitled “Systems and Methods to Improve the Efficiencies of Immunization Registries,” and filed on Jan. 22, 2007.

### FIELD OF THE INVENTION

The present invention relates to systems and methods for communicating reminders and educational information about immunizations to patients through the use of communications devices.

### BACKGROUND OF THE INVENTION

Immunizations are one of the safest and most effective ways to protect children from a variety of potentially serious childhood diseases. Ninety percent of people not immune to measles will contract the virus if exposed. If the measles vaccine was discontinued in the United States, three to four million measles cases would occur annually and result in more than 1,800 deaths, 1,000 cases of encephalitis, and 80,000 cases of pneumonia. Immunizations also are effective to protect adolescents and adults from a variety of diseases, such as influenza (the “flu”).

Currently, more than 20 percent of two-year-olds within the United States are missing one or more recommended immunizations. Parents may be unaware of vaccine requirements and believe their child is up to date when in fact the child is not. Clearly, new strategies need to be developed to protect children at risk. The United States presents a favorable environment to develop new immunization strategies. Assuming multidimensional collaboration among stakeholders in the vaccine chain (federal, state, local), successful immunization strategies require two key components to work: (1) accurate and accessible immunization data and (2) effective communications.

The creation of immunization registries represents a key improvement in immunizations data management. The Center for Disease Control and Prevention, as part of the Healthy People 2010, is finding a large number of centers to create immunization registries. The goal is to have 95% of two year-old children covered under immunization registries by 2010. Although registries have experienced significant growth since the initiative was launched, vaccine providers report important barriers that prevent them from reporting to immunization registries. Leading causes reported are: data entry costs, the fact that they are too busy and, the perceived difficulty of reporting. Strategies that benefit vaccine providers are needed to keep immunization registries growing.

Effective communications are a cornerstone of successful immunization strategies. Communications include education about the importance of vaccines and reminders or recalls. The Advisory Committee on Immunization Practices (ACIP), the American Academy of Pediatrics (AAP), and the American Academy of Family Physicians (AAFP) recommend the use of a reminder and/or recall system to increase vaccination rates.

Wireless devices (e.g. cell phones; from now on we will use “cell phones” and “wireless” as synonyms) provide an opportunity for improvement in the area of immunizations for a variety of reasons.

First, cell phones provide unparalleled access and are especially effective to access low income, under-immunized populations. Cell phones are the most prevalent personal communication channel in the US. They are used by roughly 200 million Americans and there are more cell phones than landlines in the US. Cell phone allows the use of text messaging, communication method used daily by large portions of young underserved populations that is ideally suited to encourage health-promoting behaviors. In a recent study we conducted at Columbia University to evaluate cell phone/text messaging habits in young NYC women, a majority of participants had cell phones (70% of low income and 90% of middle high income) and 90% of users knew how to read and send text messages. The average cell phone user had her cell phone on 20.4 hours per day. By contrast, only 17% of low-income people had email accounts and checked them every day. Unlike the PCs, regular mail and landlines, wireless devices are an underutilized channel to communicate with caregivers and patients in the US.

Second, cell phones are highly effective to improve immunization rates. Wireless text messaging (or SMS) is a technology that has successfully been used in clinical trials to improve vaccination rates up to 100%. A few European hospitals and health plans offer cell phone reminders for certain immunizations. To assess feasibility of SMS interventions Columbia University School of Public Health conducted a small text messaging pilot. We sent a series of 3 reminders and 2 recalls to pilot participants and obtained excellent results: 58% of the people who received messages gave their children a shot within two weeks of receiving the messages. Social workers reported that the messages visibly increased the interaction with the parents.

Third, cell phones are caregiver friendly. They allow sending text messages, which patients find easy to open and useful. A large portion of patients report they would like to receive immunization education via text messages. In the 2,500 people survey, a call to a cell phone and text messages were the preferred contact methods. Landline calls, emails and voicemail were less preferred.

Fourth, cell phone text messaging offers other superior features over the traditional reach out methods, mostly mail and regular or automated calls. The cost of a text message (can be lower than 5 cents) is much lower than the cost of a mail reminder. For the cost of a reminder card, ten to twenty text messages can be sent. Regular mail does not allow for just in time interventions to remind the person to go to a visit the day before the appointment. Traditional automated calls are a much less private communication tool than cell phone directed interventions. An automated call that reaches a landline can be answered by anyone in the house, endangering personal privacy, whereas cell phone targeted interventions reach a personal device that even allows for password protection if desired. In addition, cell phones allow sending text messages, a less invasive form of communication. A regular automated call is louder and requires picking it up immediately to avoid triggering the voicemail. A text message can be accessed anytime. It is scientifically documented that most people tolerate a very high number of text messages. It is not clear that people will have the same tolerance for voicemail.

Fifth, wireless devices can establish a powerful dialogue between healthcare providers and patients/caregivers. Present opportunities are focused around text messaging, instant messaging, or email. However, multimedia messaging including pictures and two way video casts may become mainstream a few years form now. Collecting wireless device information is key because it allows developing wireless-specific strategies to improve immunizations, in line with what the market demands.

We currently have two independent powerful tools to improve immunizations, immunization registries (“registries”) and wireless devices. Properly combined, these tools provide an unparalleled opportunity to improve the immunization status of children. Registries are currently asking doctors to report information such as the parent's telephone number and the child date of birth to improve data matching. Thus doctors, using the standard reporting channel, can collect cell phone information that allows Registries to send customized text immunization reminders. This strategy provides registries and doctors with a win-win. First, it has been scientifically proven that text reminders improve vaccination rates. Second, reminders facilitate immunization follow ups, providing doctors with an incentive to report to Registries.

Doctors' offices are in need of systems that reduce follow up/reporting costs, save staff time and increase the number of children visits. A recent report published by Vodafone claims that the NHS of England could save £240-370 million (about $420-647 million) by introducing SMS appointment reminders for patients. The authors of a new study on text messaging to improve patients follow up states that: “The introduction of this (text messaging) service has resulted in a significant saving in staff time”.

The systems and methods described in the patent specification turn providers' concerns (data entry cost, too busy, perceived difficulty), into advantages, improving registries reporting rates. Doctor's follow up costs can be lowered from 100% to an estimated 27%, when most follow ups are made by the registries. Reminders benefit providers by bringing parents to their offices. In addition, online-based registry reports greatly facilitate HEDIS reporting and revenue collection (if doctors receive pay-for-performance). Finally, the registry can automatically remind doctors when children are not up to date via email and provide online confirmation of patient follow ups. In other words, doctors have another strong incentive to report easily available information if that helps them manage complex patient follow ups.

### SUMMARY OF THE INVENTION

The patent specification describes systems and methods for setting up and sending healthcare alerts (e.g. immunization reminders) to patients/caregivers through the use of communications devices (e.g. cell phones). Although in the preferred embodiment, the invention is used to exchange information that creates immunization reminders, the systems and methods presented can also be used for other medical purposes, such a medical appointment, screening or therapy.

In an embodiment, information is collected from patients or caregivers about their wireless devices (e.g. cell phones) and, a third party (e.g. doctor) reports that information to an immunization registry. The registry is linked to a system that uses the wireless device information to generate automatic wireless immunization reminders, recalls and educational messages.

In an embodiment, the system notifies providers/Health plans about the status of the follow up (e.g. performed, not performed, responses to the message/s) for a particular person or for a group of individuals.

In a preferred embodiment, doctors or other vaccine providers, report consented cell phone information of the individual/caregiver (in case of children) to public immunization registries (e.g. NYC immunization registry). The registry has a platform that delivers a series of wireless text messages, emails or multimedia messages to the recipient that fit the individual's immunization status or educational needs.

The first step is to collect cell phone information that feeds the immunization registries. Embodiments of the present invention address the need in the prior art of creating an effective method that allows registries collecting wireless information to develop cell phone specific interventions. In a preferred embodiment, the current reporting channels, healthcare providers are leveraged to obtain this information. Providers, when collecting other information, can ask for cell phone information. Cell phone information can be entered in a simple mark or additional field in the current reporting forms (physical or virtual). This maximizes the value of information exchanged between physicians and registries, and also improves patient to physician interaction. The messages can be personalized with the provider's name to obtain a higher response rate and strengthen the link between the patients or caregivers and providers.

Secondary sources of cell phone information can be MCOs or public agencies (e.g. Medicaid, Medicare, DHS). Other secondary methods may include partnerships with wireless carriers to obtain cell phone lists.

Even if the cell phone information was available, there is a need in the prior art to let the registries know that the patient/caregiver is willing to be reached by cell phone. One way to obtain consent is to have a check box or equivalent (e.g. signature), that providers report to let the registry know that the cell phone user consents to be reached and agrees to the terms and conditions of the service. Secondary ways to obtain consent can be online login at certain websites to opt-in for the service or replying to an automated message (could be a text message) sent by or on behalf of authorized healthcare provider or entity (e.g. registry, the patients' MCO, provider).

Once the registry has the cell phone information in the preferred embodiment, it uses the information to send wireless reminders to parents/caregivers, according to their current records and/or standard immunization calendar. The registries can also send immunization updates and educational content as part of the reminders or as separate messages. In order to send the messages, the registries database must be linked to a platform that allows sending the messages directly or through a secure outsourced network.

The patient/caregiver receives the message and can confirm reception, request feedback, or answer a question.

The effectiveness of the system can be measured by two main outcomes: improvement in reporting rates and improvement in immunization rates. As control group it can use past data, a group of voluntary controls or people who are not receiving wireless reminders covered by the registry providing the service or comparable registry.

Providers can check online the status of the immunizations. They can also opt-in for reminders of children that appear not up to date in the eyes of the registry. This information allows providers to call patients/caregivers themselves or request a series of wireless recalls if appropriate.

The automatic follow up information is part of the registry's database and can be used to generate reports on follow ups that can help doctors in a variety of tasks, including HEDIS reporting to health plans.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

In order to better appreciate how the above-recited and other advantages of the present inventions disclosed herein are obtained; a more particular description of the improved methods and system briefly described above will be rendered by reference to specific embodiments thereof, which are illustrated in the accompanying drawings. These drawings depict only typical embodiments of the invention and do not therefore limit its scope. The embodiments of the invention will be described and explained with additional specificity and detail, including through the use of the accompanying figures.

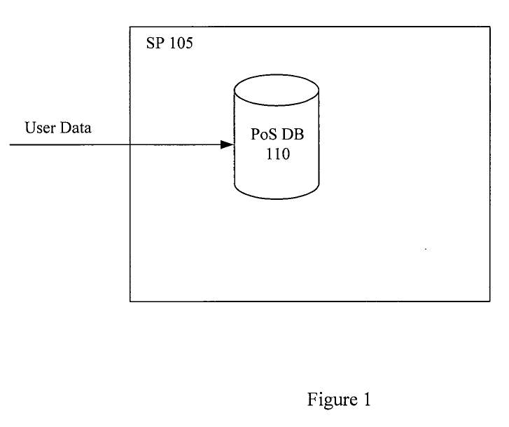

FIG. 1 illustrates a subsystem for Point of Service (POS) registration according to an embodiment of the present invention.

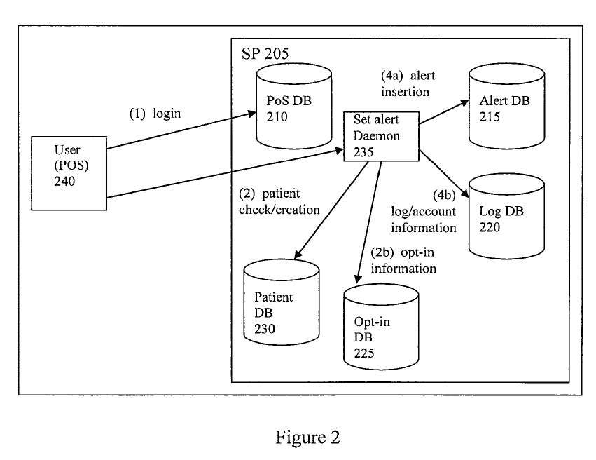

FIG. 2 illustrates a subsystem for setting up an alert according to an embodiment of the present invention.

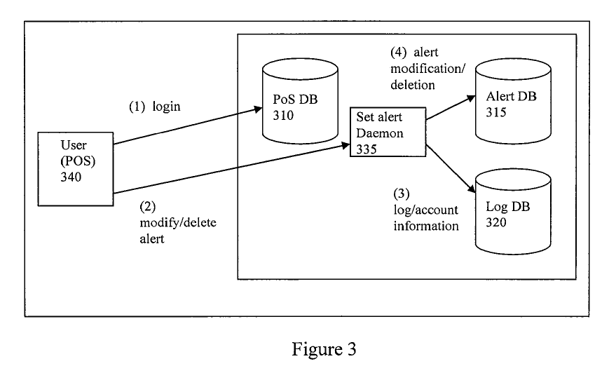

FIG. 3 illustrates a subsystem for modifying and/or deleting alerts according to an embodiment of the present invention.

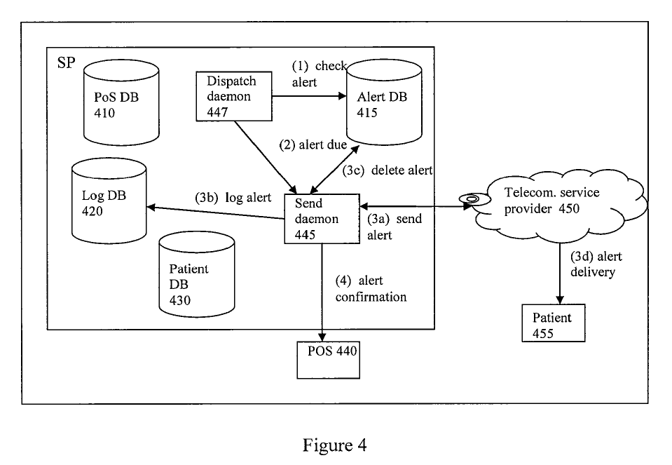

FIG. 4 illustrates a subsystem for sending alerts to the patient/caregiver according to an embodiment of the present invention.

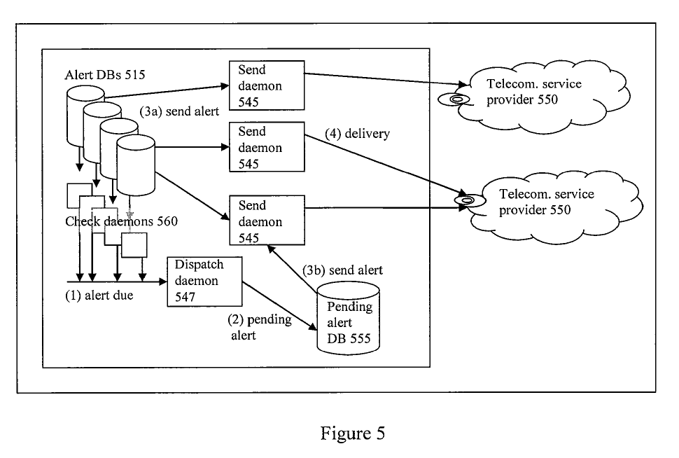

FIG. 5 illustrates a load-balanced subsystem according to an embodiment of the present invention.

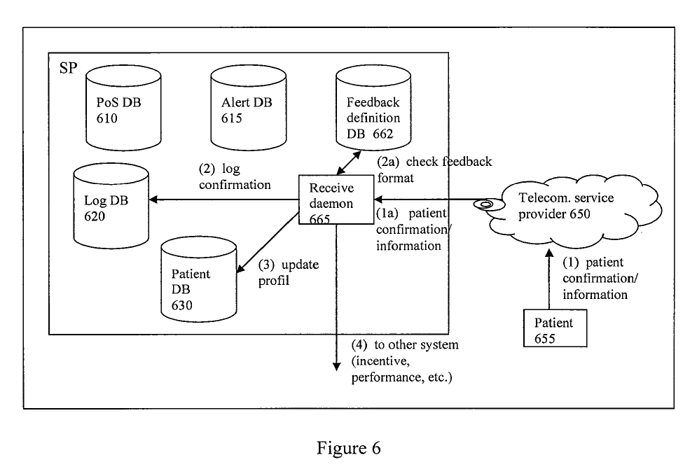

FIG. 6 illustrates a subsystem for receiving and analyzing feedback information according to an embodiment of the present invention.

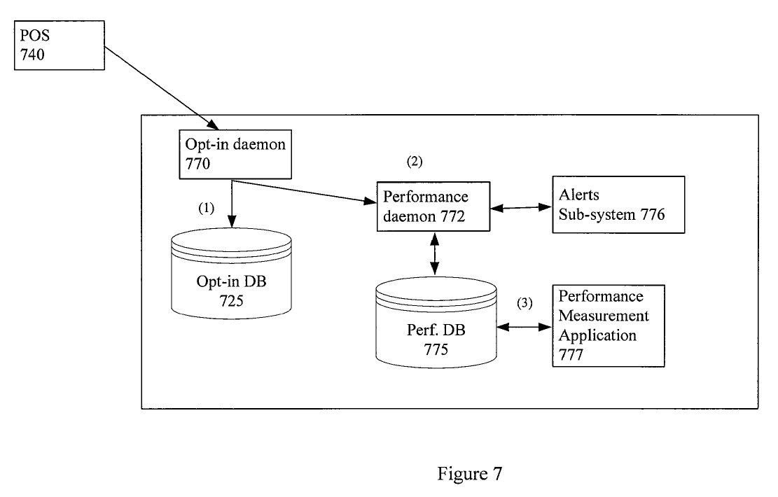

FIG. 7 illustrates a subsystem for performance-related storage according to an embodiment of the present invention.

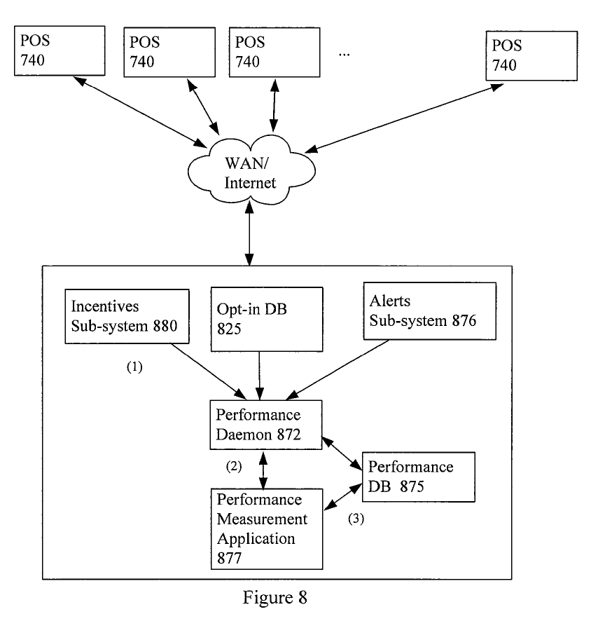

FIG. 8 illustrates a subsystem for performance analysis according to an embodiment of the present invention.

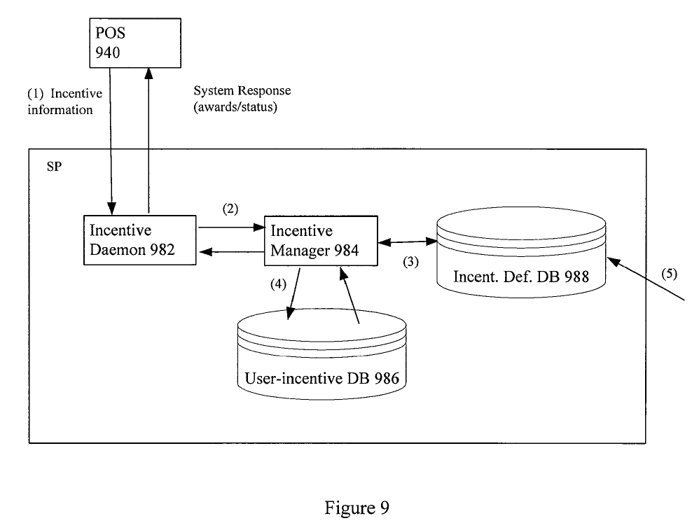

FIG. 9 illustrates an incentive subsystem according to an embodiment of the present invention.

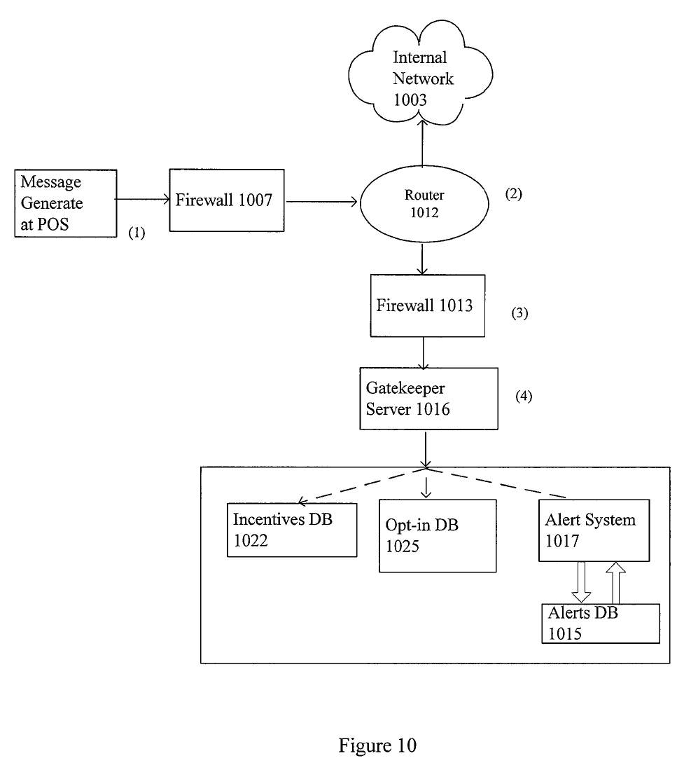

FIG. 10 illustrates a security subsystem according to an embodiment of the present invention.

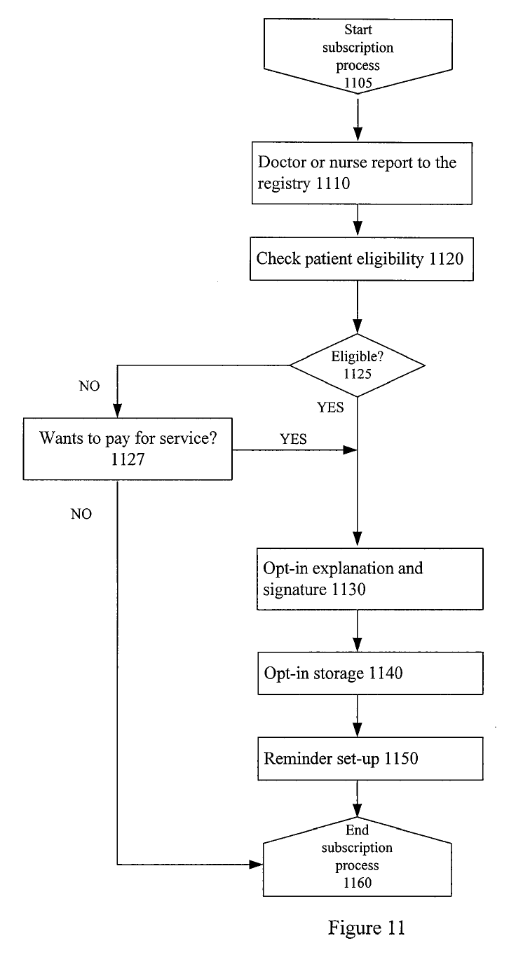

FIG. 11 illustrates the operation of an eligibility and subscription subsystem according to an embodiment of the present invention.

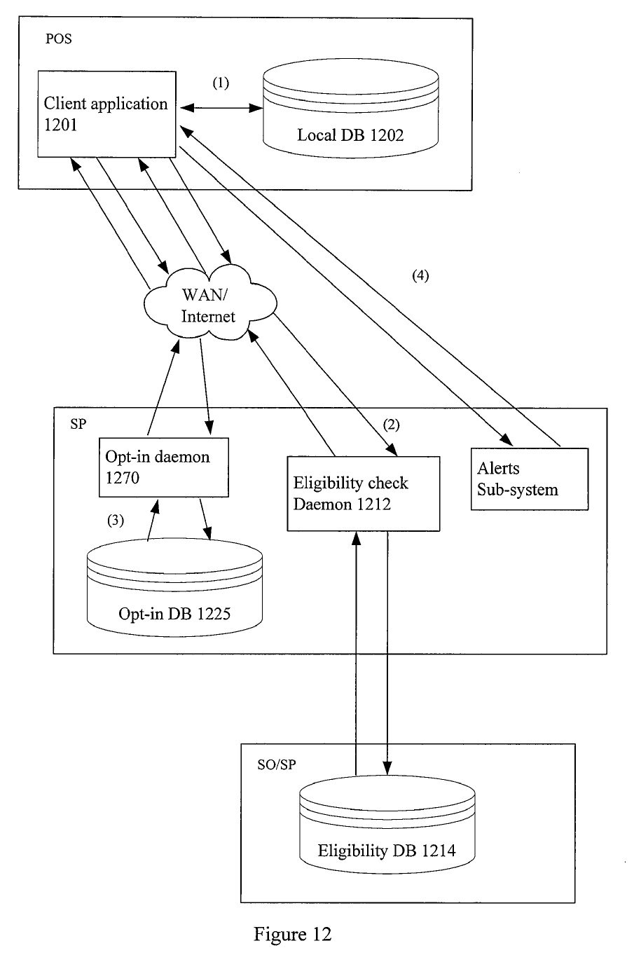

FIG. 12 illustrates an eligibility and subscription subsystem according to an embodiment of the present invention.

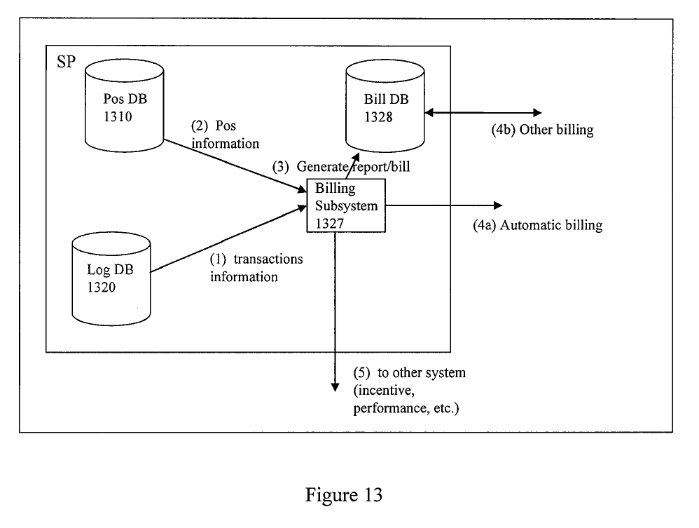

FIG. 13 illustrates a billing subsystem according to an embodiment of the present invention.

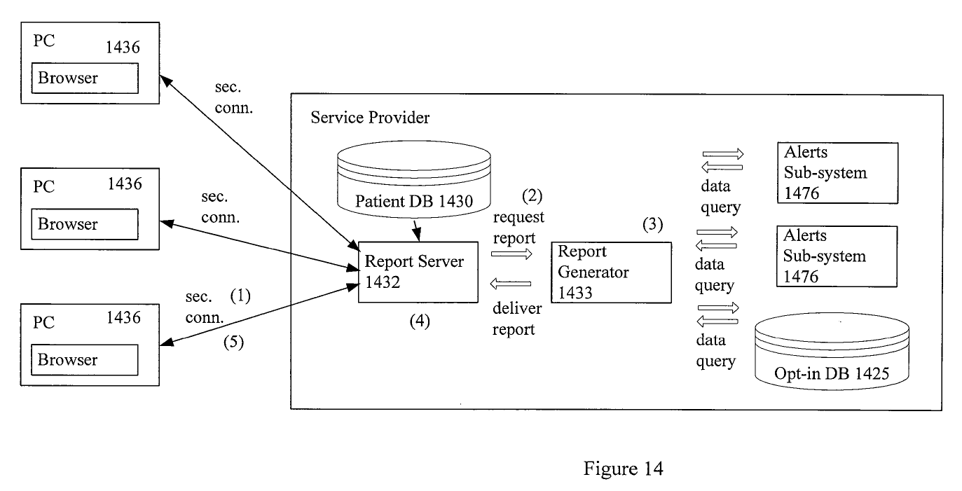

FIG. 14 illustrates a patient profile remote access subsystem according to an embodiment of the present invention.

### DETAILED DESCRIPTION OF THE PREFERRED EMBODIMENT

A high level overview of the methods and systems in the preferred embodiment is presented, and then a detailed description of the system and its operation is discussed.

Parties Involved in the Process

Sponsor: Each party that provides funding for paying the reminder service maintenance and/or incentives offered to a certain patient/patient group.

Service Provider (SP): A party that manages the operations of the reminder service program on behalf of a group of sponsors.

Point of service (POS): The POS is where the patient, or someone on behalf of the patient, interacts with the service provider to modify the patient status information. A point of service may be a primary care physician, vaccine provider, immunization registry, bidirectional wireless device, phone call, fax, web site, a combination of these channels, etc.

Patients/Caregivers: Participants in the reminder program and recipients of the immunization regimen. A caregiver may receive the reminder for a patient, as when a parent receives the reminder for a child.

Main Functions Developed by the System

Reminders Operations: Task that consists of (1) data input at the point of service; (2) alert activation; (3) data reception by the SP; and (4) delivery of data by the SP.

Incentives/Awards: Part of the method related to offering/managing incentives system whose goal is to engage the patient into the service. It may require an eligibility and billing process by itself.

Performance measurement: Task that consists of (1) collecting performance data from the POS; (2) analyzing the performance data; and (3) quantifying the earnings/savings/satisfaction generated by the program.

Profile Access: Patients, physicians, and authorized health care providers can register to access the patients profile and check information. Examples of information are: alerts patients are receiving, patient response rate, feedback provided, incentives eligible, awards received, health care news patients are subscribed to, opt-out, etc.

Other Functions Embedded in the Main Functions

Eligibility checking and Subscription: Task that consists of (1) informing the POS whether the patient is eligible for the program. The parties informing the POS are the SP or, in some instances, the sponsor. Eligibility data comes from data/criteria provided by sponsors. (2) Creating at least a patient profile after having executed a series of the eligibility for checking.

Billing: Task that consists of recording all the operations done by the POS or SP that must be reimbursed by the sponsors.

Security: Task integrated in other functions whose goal is to allow the secure storage and exchange of information, as well as the authentication of the users receiving such information. HC information is sensitive and subject to HIPAA regulations. Examples of security procedures that are required to allow the method operate in a commercial setting are: authentication, encryption, firewalls, back-ups, or protection against catastrophic events.

System Set-Up

The system can be setup in two ways:

(a) A software, either standalone or integrated into prior POS software.

The software includes enough patient/prescription information (see required information) to allow: (a1) creating/modifying/deleting a patient profile (a2) searching a patient profile (a3) adding/modifying/deleting series of immunization regimens associated to a patient whose data will be used to generate a series of messages that educate and/or remind the patient to comply with its immunization regimen. The Software SetAlert (Connect US proprietary software) provides an example of the type of software we are referring to.

(b) A secure web site that emulates all the functionalities of the software above described that can be accessed by HC personnel and, with different user privileges, by the patient/s.

Note to system set up (a) and (b): The system requires a secure connection, either through an open network or through closed HC networks to transmit the regimen information directly, or through a third party (insurance, PBM), to the service provider.

First Time Use:

Opt-in: the patient, or a party with the required authority to subscribe the patient, must have to opt into the reminder service. An example of an opt-in mechanism includes: printed form, electronic form/signature or wireless electronic message with the purpose of subscribing an individual to the reminder program; privacy terms are stated if necessary.

Even if a patient gives permission to receive the reminders, that by itself does not exempt the service provider from any liabilities derived from service failure or misuse. Also, there is a possibility that the alerts could be set up and delivered by mistake without patient express approval if a security mechanism is not coupled to the alert delivery mechanism. Thus, the method can include a tailor-made security mechanism to manage the patient compliance program. An example of process and mechanism is presented in the points (a) to (e):

(a) The patient gives permission to receive at least one immunization-related reminder or the required information to generate reminders on a patient device.

(b) A valid proof that the patient agrees and authorizes to exclude all agents providing the service from any liability derived from a patient misuse of the reminder and/or service failure and any other potential liabilities included as terms and conditions.

(c) There is an input either of the proof itself or an action confirming the proof confirmation into a software application.

(d) A computer system that can be located at the point of patient care and/or outside it, checks whether the proof/confirming action has been stored into the system.

(e) The same or another computer performs one or all the following actions:

(1) not allowing input or activation or download of any alerts if the proof/confirming action is not found in place;

(2) deactivating the alerts in case the agreement proof is not successfully verified notifying the Point of service and/or the Service provider and/or the patient that the information is not in the system and/or its consequences.

The system may or not include a local and/or remote log database where proof/confirmation of the patient agreement can be sent, stored, and found in case of controversy or consultation need. The mechanism must be used just the first time the service is offered, every certain time, or every time that a prescription is filled.

Funding/subscription Checking: The POS can send a query to the SP database (or have a internal system) to check that (a) the patient is eligible for the reminder system, (b) there is a sponsor available to pay the service on behalf of the patient—Sponsors may include HMOs, the government, and/or drug manufacturers, (c) incentives are available if the patient complies with her therapy and/or meet other required criteria. If the answer to (a) and (b) is yes, it can proceed to the alert set-up. If the answer to (b) is no, the patient may opt to pay the service her/himself using paying methods such as credit card, check or cash, directly or through a website.

In either case, the POS can decide to set-up the alert and the SP will activate the service. If (a) and (b) are found to be right when the data from the POS is received at the SP, the SP can continue the process to send the reminders to the patient (assuming all other required conditions have been fulfilled).

Reminder set-up: the POS enters the required drug/immunization regimen and patient data to activate the reminder service. As mentioned before, the point of service is helped by a template system that allows him/her to input the prescriptions faster. Also, there is a mechanism to detect and notify when several prescriptions are taken together and merge all or part of the messages. That can be done by the point of service, but it could also be done by the service provider system.

Reminder Activation: it can be done in several ways: (a) automatic (preferred method): first time activation coupled to a healthcare service visit. For example, when the patient receives a shot, the cell phone information is sent to the immunization city registry, which sends a message to the SP to activate the alert system. Note that the mechanism can be initiated by patient, doctor, authorized third person, or automated channel (e.g. the patient calls a phone # that recognizes the patient cell and activates the service, the doctor sends a wireless message/email to the SP when a shot is given). (b) Predetermined activation: in the cases when the time in which the patient is going to receive the shot/s is known with enough accuracy, a pre-established activation time can be setup. (c) Patient-initiated activation can be done via a POS such as a website or a doctor's practice call center. Patients knowing their upcoming immunization needs may be able to initiate the activation process by themselves.

Sending data to SP: either when the alerts are set up or when the system is activated, the patient profile will be updated by the SP.

Alert delivery and feedback: the patient receives the alerts at the right time. The messages may require patient feedback, which may involve sending a message of reply, a phone call or other. The SP can use feedback to measure the service efficiency and contact the patient if required.

Patient profile access: a login and password is issued to authorized patients/HC providers to access the patient profile online (e.g. check incentive status, read HC news, check patient refills and feedback).

Service Continuation

As the SP is independent from the POS, the service can be started at specific POS and conveniently continued at any other POS. Service continuation happens when new alerts for new shots or for a different drug regimen are set up at a new POS for a subscribed patient.

Continuation Intermediate Steps Comprise:

Opt-in continuation: the POS may require proof that the patient knows the terms and conditions related to being subscribed to the service (especially, the liability side).

That may be verified by:

(a) Initials/signature in a POS document. A clause is added to these documents specifying that the patient/authorized person agrees to continue receiving the service. The preferred method for opt-in continuation is coupling the activation to the initial digital or physical document the patients sign when receiving a healthcare service. (An addendum to the document detailing that, by signing it, the patient continues to agree to the terms and conditions of the service may be needed.) (b) Entering/providing the POS with a PIN or password that will be required to continue/activate the reminder system (SSN last 4 digits, other). (c) Sending/replying/calling to SMS/email/telephone number sent/provided by SP. (d) Swiping or showing a card/ticket or other mechanism that may work as ID and confirmation. (e) Any other kind of authorization by the patient or authorized caregiver with which the user accepts the terms of use.

The security mechanism will be coupled to any of these actions to ensure that all alerts are sent following the software aided security protocol.

Funding/subscription checking: The opt-in confirmation check can be coupled to the funding step. Also, if the patient was subscribed to an incentive system and has met certain criteria, the system may indicate so too.

Reminder set-up: the POS enters the required data to activate the reminder service.

Activation: same as in step 1. Either when the alerts are setup or when the system is activated, the patient profile will be updated at the SP.

Sending data to SP (can be coupled with activation): any data related to shots and/or incentives is sent to allow (1) the correct performance of normal system processes (operations, security, other), (2) the measurement of the reminder system performance, (3) the accumulation/redemption of any awards the patient is eligible to.

Alert delivery and feedback: the patient receives the alerts at the right time. The messages may require patient feedback. The SP can use feedback to measure the service efficiency and contact the patient if required.

System Description

The system can be understood as a sum of subsystems that interact and develop different functions. Some elements are subsystem specific while some others are shared by several subsystems. An overview of the subsystems and their main elements is described. Detailed examples of each subsystem are provided below. Note that the system example emphasizes the service provider mechanisms, and the use of wireless reminders. However, other possible ways of providing the service are available.

System Agents

Service Provider: Entity that administrates and controls the reminders system. It is in charge of administering, and managing the database of POS, patients, and alerts

Points of Service (POS): The agents authorized to register in the reminder system and set up, modify and cancel alerts. They need to be given access to the system using a login and password or other authentication form. Examples are a pediatrician, a Primary Care Physician (PCP) or the immunization city registry.

Patients: Individuals subject to a vaccine treatment to which the alarms are set up for.

System Objects

(0) POS DB: Database containing the information of the POS authorized to use the reminder system. Primarily contains the user and password for the POS and a set of permissions for set up, modify or cancel alerts. Upon login, the POS will most likely have access to a view of the system comprising their own alerts only (i.e., they can not access alerts or any data that do not belong to the POS). The POS DB may have other information that the service provider may use such as billing information or status.

(4) Patient DB: The service provider may maintain a database with patients for which alerts are sent. This DB is not required, as the Alert DB contains all the necessary information to remind patients/caregivers. However, if the service provider uses the patient information for other purposes (such as monitoring compliance, incentive systems, etc.), the POS may introduce their patients in this database (see incentive, opt-in DB, etc.). The patients are identified by a unique ID and may be related to more than one POS.

(7) Alert DB: The database with the alerts information. It contains information about the sender (POS, PCP, or any other trusted source for the patient), the destination (patient cellular number, e-mail, other), the message and the date and time of the reminders. The alerts are introduced by the POS, which may also select the message for the reminder using software such as SetAlert.

(3) Log/Account DB: The database in which all the operations (messages received, sent, alerts stored/modified, etc.) are stored. This database is used for logging purposes (for example to detect errors) and it also may be used for performance measure and accounting. For example, it may store the completed transactions for billing purposes, or may be further used to calculate statistics on the operation of the system (load, stress, errors, etc.)

(2) Billing DB: A database where all the billing information is stored. For every billing cycle the billing system would generate bills and reports that would be stored in this database. The billing information is stored for accounting purposes and may be consulted at any time.

(16) Incentive Definition DB: The database in which all types of incentives and eligibility criteria are stored.

(17) Incentive-Patient DB: The database that keeps all patient profiles linked to their incentive-related data (actions, awards, other).

(19) Performance DB: The database to which all data required to analyze performance is sent.

(23) Eligibility DB: The database where all the criteria for eligibility reside.

(5) Opt-in DB: The database that stores all information related to patient opt-in/op-out.

Reminder Subsystem

Point of Service Registration: This phase deals with the introduction of the POS in the Service Provider Database. This method might be automatic but it would usually require direct operation by the Service Provider. The main POS information is the POS unique identifier and name and login information (POS_ID, POS_NAME, POS_LOGIN, POS_PASSWD). The POS needs to log into the reminder system to set up alerts. Other POS data may contain information useful to the service provider such as billing, address and contact information. An example of the POS registration is shown in FIG. 1, which shows user data being sent to the Service Provider 105 and stored in a POS database 110 in the Service Provider 105.

Similar processes can be used to modify or delete the POS information in the database.

Alert set-up: In this phase the point of service (POS) sets-up the alert to remind a patient/caregiver. An example of the alert set-up is shown in FIG. 2. (1) First the POS 240 logs into the system and gets access to their own view of the system (e.g., patients and alerts set up by the same POS). The connection to the Service Provider System 205 may be done by TCP/IP using a web server or by any other remote communication mean. If the POS 240 has a database of the patients and their alerts, then (2) the POS 240 checks if the patient already exists in the patient database 230. If not the POS 240 may create an entry for that patient in the database 230. In order to allow a patient entry creation the opt-in information of the patient has to be present, for example in an external opt-in database 225 (2b). The patient information only requires a user ID (such as SSN) and a way of contacting the patient for the alerts (e.g. cellular number, e-mail address, etc.). The patient database 230 may also include other information about the patient such as compliance rate, health provider, information related to the performance or to incentive systems described for this patent. (3) The next step is the setting up of the alert. The alert would have a unique identifier (ALERT_ID), and requires information about the POS (e.g. POS_ID), alert message (introduced by the POS, ALERT_MSG), destination (patient cellular number or e-mail: ALERT_DEST) and scheduled days/times of alert (ALERT_SCHEDULE). The information about the alert may be extracted automatically, for example, by connecting to an automatic reader (barcode reader) or may be introduced directly by an operator in the POS 240. While no other information is required, other additional information may include different ways of contacting the patient/caregiver (cellular, phone, e-mail), a patient ID (in case the POS stores other sensible information about patients and alerts), type of drug, patient's health insurance, etc. The alert system is governed by the set-up alert daemon 235 that processes the alert insertions. (4a) The set-up daemon 235 processes the information and stores the alerts in a suitable format for the reminders (for example, a single prescription corresponding to 8 reminders may be transformed to 8 entries in the alert DB 215). (4b) The set-up daemon 235 also stores information in the log/accounting database 220 about the transaction (for example for billing purposes).

Alert modification/deletion: Alert maintenance is done in a similar way as the set up, except that there is no need to modify the patients database. An example of alert modification/deletion is shown in FIG. 3. (1) The POS 340 logs into the system, and (2) executes a delete or modify to an alert. The login information would identify the POS 340 so it can only modify alerts that the same POS 340 has already created. (3) Then the modify/delete information is logged in the Log DB 320 and finally, in (4) the alert is modified or deleted in the alerts DB 320.

Alert dispatch: Once the alert is established in the Alert database 415, the dispatch daemon (1) 447 checks periodically for alerts to be sent, an example of which is shown in FIG. 4. When an alert is due (2), the dispatch daemon 447 queues the reminder with the send daemon 445, responsible for the actual sending of the reminder. The send daemon 445 interfaces with one or more telecommunication service provider 450 and (3a) sends the reminder in the appropriate form (e-mail, short message, voicemail etc.). The communication with the telecommunications provider 450 is done via a communication network such as TCP/IP and using a signaling protocol such as SMS/MMS or email. The connection to the communication provider 450 may be through Internet or by a direct point-to-point connection such as ADSL, ISDN, Frame relay or cable. The alert delivery may be confirmed by the telecommunication service provider 450. When confirmed, the send daemon 445 (3b) updates the log/accounting DB 420 (for example for billing purposes) and (3c) deletes the alert from the database 415. In the case of an error the send daemon 445 may mark the reminder as faulty, logs the event and may communicate to the dispatch daemon 447 to try again later (e.g. by marking the alert time 10 minutes later). The reminder eventually (3d) arrives to the patient 455 and a confirmation (4) may be sent to the POS 440.

Load-balanced design: The system may be designed to handle high traffic load. An example of a load-balanced design is shown in FIG. 5. Separate set-alert, dispatch and send daemons are designed to avoid blockages on the process and enqueue commands. For example, alert DB may be a farm of alert databases 515 and the send daemons 545 may be distributed in several CPUs. Each database 515 is serviced by a different dispatch daemon 547 that informs when an alert is due (1), several check daemons 560 (2) send the alerts independently to the dispatch daemon 547 that informs one or more send daemons 545 of the pending alerts or may send the alert to a Pending Alert DB 555, to alleviate the load in the main databases. The send daemons 545 may in parallel gather the information about the alert directly from the alert databases 515 (3a) or from the pending alert DB 555 (3b). Finally (4), the send daemons 555 may deal with one or more telecommunication service providers to balance the delivery load.

Feedback reception/analysis: The alert system can receive feedback information from the patient/caregiver. An example of this is shown in FIG. 6. (1) This feedback information may be patient 655 initiated (for example to request information from the system) or may be as a result of an alert delivery, in which case the patient/caregiver 655 may simply respond to the alert message. (1a) All the information coming from the patients/caregivers 655 is handled by the receive daemon 665. (2) All the incoming information is stored in the log/account database 620 and (3) may trigger an update of the patient database 630, for example to update the compliance information in the case the message is a confirmation of compliance by replying to an alert. If the patient/caregiver 655 sends any other kind of feedback information, the system (2a) checks in the feedback definition database 662 for a matching format for the message. For example, the user may send the message “ALERT OFF”, soliciting the temporary deactivation of the alert system. In this case the receive daemon 665 would check in the feedback definition database 662 for messages of the form “ALERT ON/OFF” and would interpret the query and trigger the subsequent actions, such as logging, deactivation of the alerts or communication with external subsystems such as the incentive/performance engines (4). Note that the system may produce further responses to patient information. These may be handled as regular outgoing alerts or by other means after parsing/inspection of the user response. The system may have certain responses parameterized that trigger pre-configured responses to the patients.

Performance Measurement Subsystem

### Example 1

### Performance-Related Data Storage Shown in FIG. 7

### Example 2

### Performance Analysis Shown in FIG. 8

Patients are informed in the opt-in forms of the use of the alert system for the purpose of improving their health and the general well-being of the population at large. This includes the use of alerts' statistics to track compliance and to follow-up on the patients' fidelity to the system (shots administered, feedback, coupons, other). As exemplified in the FIG. 7, (1) opt-in information is stored and kept with the patient subscription to the service. Opt-in information is sent either with paper records, electronic signatures or other methods of validation, as explained elsewhere. Current alerts' information is stored in the alerts database. Since this database would store only active alerts it is necessary to keep track of the alert history of a particular patient. (2) This can be done by the performance daemon 772, a process running in one of the computers of the SP. The performance daemon 772 would query regularly the alert database 776, select those alarms that correspond to patients for which the performance measure is being done. The importance of regular polling comes from the fact that alerts may be changed either by the patients/caregivers or other users that are authorized (the provider, the POS, the SP etc). The performance daemon 772 would make sure the changes are accounted by querying regularly and updating the information stored for which changes have been made.

(3) The information from the alert subsystem 776, along with the opt-in information, would be stored in a performance database 775. The performance database 775 may be composed of a set of tables. One table could consist of a list of patients for which performance is being measured. A simple implementation of this would be a table with only one column called PATIENT_ID. Other lists may included message type, or patient characteristics. Another table would keep track of alert and opt-in/continuation information for each alert that has been set up in the system. Every record of this table could include the fields: PATIENT_ID, DAY_SET, LOCATION, MEDICINE/VACCINE and DOCTOR. Finally, a set of tables representing lists of patients in different studies could be optionally included.

These lists would each represent a specific performance study that is being carried out. Another important component for performance studies would be the incentives database. The incentives database includes information about specific incentives given to patients/caregivers, including dates and terms.

Referring to FIG. 8, the Performance Measurement Application 877 would be an executable process that is able to run queries over the data stored in the different databases mentioned. It would be able to create groups of patients that are under study and pool together alert, incentive and opt-in information. The reports generated from this application could then be compared to control groups and make comparative studies. A more comprehensive study could be done in which demographic information of the patients could be asked. This data would be gathered as an alert with extra information. The patient/caregiver would be informed of the purpose of these questions and the extra information from the alert would be stored in extended fields of the alert database. (3) The performance daemon 872 would then, in turn, store these data in the performance database 875.

Incentive Subsystem

Incentives can be tracked as is shown in the FIG. 9. (1) When the POS 940 sets up an alert on behalf of the patient it sends incentive information (e.g. successful compliance) that is received by the incentive daemon 982, which (2) activates the incentives manager 984 and passes as parameters the data from the alert. (3) The incentives manager 984 would check for incentive eligibility of the patient and/or prescription and would then (4) store the information relevant for incentives management in the user-incentive database 986. One type of incentive could be given to patients that get their shots as prescribed. (5) The Incentive Definitions DB 988 would include the criteria for which an incentive is awarded and these definitions can de defined by the SP, SO and POS. The incentive database would have a table with the fields PATIENT_ID, DAY_SET, PRESCRIPTION/VACCINE_ID, REFILL/SHOT_NUM and TOTAL_REFILLS/SHOTS. The PATIENT_ID and the PRESCRIPTION/VACCINE_ID uniquely identify the patient and the prescription/vaccine, the DAY_SET is the day when the alert was set, REFILL/SHOTS_NUM is the refill or shot order out of the total number of refills or shots of the prescriptions, which would be the value of TOTAL_REFILLS/SHOTS. Whenever a new alert were handed to the incentive manager it would query the incentive database for past alerts with the same PRESCRIPTION/VACCINE_ID. If the patient had set a previous alert for the prescription or shot then this refill would qualify for an incentive. The incentive could then be offered in different ways. One scheme would be to send a message back to the POS with the incentive redeeming details, such as cash rewards. This would be done by making the alert daemon wait for an answer of the incentive manager. The alert daemon sends a message of acknowledgement to the POS communicating that the alert has been set up successfully. In the case that the patient had been awarded an incentive this message would include information about the patient's reward that then could be used directly at the POS. Another scheme would be to send a message to the sponsor of the incentive program so that the sponsor itself would retribute the patients accordingly by formulas such as mailed checks or other (e.g. premium SMS). The sponsor would inform the SP of the incentive policies and retributions, giving specific details of which patients should be awarded and in which conditions.

The SP, in turn, would send the incentive information of the patients awarded either one by one or by sending periodically lists of patients awarded. Other schemes (coupon-based etc. are possible too).

Security Subsystem

FIG. 10 shows an example of how the SP's network architecture would be organized in order to reduce the possibility that external electronic attacks would threaten the integrity or confidentiality of the user's data. Since prescription/vaccine data is of a very sensitive nature it is necessary to structure the network in a layered fashion where the critical applications and databases sit in the innermost layer. (1) Electronic messages generated at the POS, or via a third party, would arrive to the SP's network via a firewall or gatekeeper device 1007 that would form a first barrier to electronic attacks and at the same time allow a range of authorized transactions such as web server queries, email and other. (2) From there, a router 1012 would direct messages either to the less critical part of the internal network 1003 or to the more critical second layer of the network. (3) The second layer of the network would be protected by a firewall 1013 which would restrict the type of messages passed only to those strictly concerned with transactions in the critical systems that keep the patient's information, such as the incentive system 1086, the alert system 1017 and the opt-in database 1025. This would reduce the possibility of attacks that would target back-door applications. (4) From the firewall 1013 the message would be passed onto a gatekeeper server 1016 that would have as main task to balance the load among the computers that run the different databases and systems. Load balancing is intended to enable easy system scalability where the increase of processing load can be distributed among a number of computers.

Eligibility and Subscription Subsystem

The process of subscribing to the alert service is composed of several steps, and example of which is shown in FIG. 11. The first step starts at the POS, where the patient is offered the service (1110). The healthcare provider may use a standalone application or an add-in to a commercial program or the patients can access a website to which they have been referenced by the provider. (1120) Criteria for eligibility may be set on an individual basis (e.g. patients with a specific insurance plan) or for patients with a demographic profile (e.g. newborns) or other (e.g. depending on the availability of the drug or vaccine), as well as for anybody purchasing a prescription/vaccine. The criteria may be stored locally in the POS or requested from the SP. If eligibility is confirmed the subscription process continues (1125). (1130) The patient signs the opt-in agreement for which it accepts the terms and conditions of the service. If the signature is electronic then it is both stored locally and sent electronically to the SP. If it is in paper then it is kept and sent by mail to the SP or scanned and sent electronically. (1150) Once this is done the healthcare provider or the application sets up the alert with the information related to the treatment. This information may include data such as the doctor that prescribed it, the number of vaccines that have to be taken, the frequency and times of administration, the dosage as well as generic or specific recommendations tailored to the patient's need, age, and treatment.

After setting up the alert the POS receives confirmation on whether the alert has been set up successfully or not.

The process of subscription involves the activation of several processes, an example of which is shown in FIG. 12. (1) Locally or remotely, the application 1202 that sets the alerts searches first for information about past vaccines or treatment history of the patient. (2) Then, if eligibility has not been confirmed already, it is checked either locally through lists of criteria programmed into the application or remotely sending a request to the SP. The SP provider may in turn check locally for eligibility 1212 or ask the SO for an eligibility check 1214. An example would be if the service is only given to patients subscribed to a specific insurance company, which is also the SO. The eligibility check would be a query on their clients' database and the answer would be sent back to the SP. This could be done by a eligibility daemon that would be in place to handle the processing and waiting for the message back from the SO.

(3) Once the eligibility has been confirmed, the opt-in signed by the patient would have to be sent to the SP. In case the opt-in was signed electronically, or scanned, it would be sent as a message that would be handled at the SP side by an opt-in daemon 1270 that would store the data on an opt-in database 1225. After accepting the opt-in the POS could go on filling out the alert options for the patients' prescription in the fields of the alert application.

The alert message would be made of a number of fields describing the alert characteristics. Those fields would match those that can be filled out in the alert application: the name of the medicine/vaccine, the doctor, the times and dosages for taking the prescription/receiving the vaccines, the number of refills/additional shots, additional medical advice and other options such as if the patient wants to receive general health care advise. This message is received by the alert daemon in the SP, which is an application generally polling one of the ports of the network memory space of a computer. The alert daemon parses the incoming messages and stores them in the alert database.

Billing Subsystem

An example of a billing subsystem is shown in FIG. 13. In every billing cycle, the billing subsystem 1327 (1) gathers the information of the transactions realized by each POS in the log DB 1320, and (2) the billing information from the POS DB 1310 to (3) generate the bills that may be stored in a Bill DB 1328 for accounting purposes. The billing subsystem 1327 may automatically (4a) generate the bills and send it to the payer (specified in the POS DB) or the bill may (4b) be generated off-line by other means. Finally the billing information may be also (5) used by other systems such as the incentive or performance subsystems.

As shown in FIG. 14, reports of the alert system status at any point in time can be generated by an interface to the system. The interface engine is the report generator 1433 and is an application that sits in a computer in the SP. This computer has a web server process that is able to undertake secure web transactions. Moreover, the computer is connected to the internal network of the SP and it may be reachable from the internet. (1) A viewing station would establish a secure web connection with the web server running in the computer 1436 with the report generator 1433, and this transaction would activate the report generator 1433. (2) The authorized viewer would be authenticated using the passwords stored in a user database. The activation parameters passed along in the request would be used to customize the data and appearance of the report. (3) The report generator 1433 would take the parameters and query the incentives, alert and opt-in databases accordingly. (4) The results of this query would be parsed and ordered to generate a report and (5) this report would be sent back by the web server to the viewing station 1436, where it would be displayed by a browser. An example of use of report generation would occur if a patient is interested in reviewing his active alerts. The patient would be provided at the time of subscription to the service with a password and an ID. These would be used to log in as a user in a website set up by the SP. A secure connection request would be sent to the web server. If the user is new, an entry in the user database of the web server would be done. The patient would be able to change his password at any point and list active alerts, which would be those having the corresponding PATIENT_ID identification. The report could be generated using standard tagged languages, such as HTML or XML., or any language readable by a user's browser.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. For example, the reader is to understand that the specific ordering and combination of method steps described herein is merely illustrative, and the invention may be performed using different or additional method steps, or a different combination or ordering of method steps in a manner that does not depart from the spirit of the invention. For example, each feature of an embodiment may be mixed and matched with other features shown in other embodiments in a manner that does not depart from the spirit of the invention. Thus, the present inventions are intended to cover alternatives, modifications, and equivalents, which may be included within the spirit and scope of the present invention as defined by the claims.

What is claimed is:

1. A method of sending a healthcare alert to a patient or caregiver, the method comprising:
receiving contact information for the patient or caregiver, wherein the contact information includes information for sending the healthcare alert to a wireless device of the patient or caregiver;
receiving opt-in information for the patient or caregiver, wherein the opt-in information indicates whether the patient or caregiver has consented to receive the healthcare alert;
receiving alert information for the patient or caregiver, wherein the alert information includes an identity of the patient or caregiver, and a scheduled time for sending the healthcare alert to the patient or caregiver; and
if the opt-in information indicates that the patient or caregiver has consented to the healthcare alert, automatically sending the healthcare alert message to the wireless device of the patient or caregiver at the scheduled time based on the received contact information.

2. The method of claim 1, wherein the healthcare alert is an immunization reminder.

3. The method of claim 1, wherein the healthcare alert is a medical appointment reminder.

4. The method of claim 1, wherein the healthcare alert is a healthcare screening alert.

5. The method of claim 1, wherein the healthcare alert is a healthcare therapy reminder.

6. The method of claim 1, wherein the sending of the healthcare alert includes sending a wireless message to the wireless device of the patient or caregiver.

7. The method of claim 6, wherein the wireless message comprises a text message.

8. The method of claim 1, further comprising:
storing the alert information for the patient or caregiver in an alert database;
periodically checking the alert database for alerts that are due; and
if the healthcare alert for the patient or caregiver is due, sending the healthcare alert to the wireless device of the patient or caregiver.

9. The method of claim 1, further comprising checking the patient's or caregiver's eligibility to receive the healthcare alert.

10. The method of claim 1, further comprising receiving a confirmation from the wireless device of the patient or caregiver that the healthcare alert has been received.

11. The method of claim 1, further comprising receiving feedback information and measuring the effectiveness of the healthcare alert using the feedback information.

12. The method of claim 1, wherein the feedback information includes whether the patient or caregiver responds to the healthcare alert.

13. The method of claim 1, wherein the feedback information includes whether the patient received an immunization specified by the healthcare alert.

14. The method of claim 13, wherein measuring the effectiveness of the healthcare alert includes comparing the feedback information to a control group of patients and/or caregivers who did not receive wireless alerts.

15. The method of claim 1, further comprising providing an incentive for the patient or caregiver to receive the healthcare alert.

16. The method of claim 1, further comprising adding an educational message to the healthcare alert.

17. The method of claim 1, further comprising automatically generating a bill for payment of the healthcare alert.
